(19) United States
(12) Patent Application Publication
(10) Pub. No.: US 2011/0208550 A1
(43) Pub. Date: Aug. 25, 2011

(54) REVERSE PAYMENT TRANSACTION SYSTEM AND METHOD

(75) Inventors: Marc-André Lamarche, Lorraine (CA); Jean-Sébastien Boulanger, Boucherville (CA)

(73) Assignee: CODAPAY, Lorraine, QC (CA)

(21) Appl. No.: 13/123,067

(22) PCT Filed: Oct. 5, 2009
(86) PCT No.: PCT/CA2009/001406

§ 371 Date: May 11, 2011

Related U.S. Application Data
(60) Provisional application No. 61/136,830, filed on Oct. 7, 2008.

(51) Int. Cl. G06Q 30/00; G06Q 40/00

(52) U.S. Cl. 705/4; 705/16; 705/14.51

(57) ABSTRACT

A reverse payment transaction system and method in which the consumer, rather than disclosing his financial details, acquires a unique reference code associated with a bill registered by the merchant in a payment processor database. The consumer then acquits the payment through a trusted channel of choice. The method comprising the steps of providing a payment identifier associated with the purchase to the consumer, receiving at a point-of-sale the payment identifier from the consumer, providing the payment identifier from the point-of-sale to a payment processor, receiving the invoice at the point-of-sale from the payment processor, receiving payment from the consumer at the point-of sale, indicating to the payment processor that payment of the invoice was made, generating on the payment processor a receipt and providing the receipt to the point-of-sale.

### TECHNICAL FIELD

The present invention relates to a reverse payment transaction system and method.

### BACKGROUND

Commonly, a wide range of payment methods are available to consumers of goods and services: credit cards, debit cards, checks, cash, prepaid cards, and others. Most of those payment methods require the consumer to transmit either financial information or a negotiable instrument to a merchant (or a payment processor chosen by the merchant). The merchant usually uses the consumer's financial information to debit the amount of the payment from its bank account, credit card margin, or other. These payment methods are comprehensive for the consumer when he can trust the merchant and the channel over which his financial details are transferred (e.g. in person).

The advent of e-commerce over global information networks (the Internet) has facilitated commerce between consumers and merchants located all around the world, hence requiring the transfer of payments between parties located far apart, possibly in different legislations. As of today, the payment methods that are mostly used in e-commerce are adaptations of the same traditional payment methods that require the disclosure of consumers financial information (credit cards, checks).

A problem arise in that these payment methods require the consumer to transmit financial information to an untrusted party (a merchant or payment processor located far away, possibly in a different legislation) and/or over an untrusted channel (the Internet) to complete the payment. Even with the advancement of encryption technologies such as public-key cryptography, many consumers are still not ready to take the risk of transmitting sensitive information over the Internet.

Other solutions exist such as e-cash or prepaid cards where the consumer does not have to disclose information over the Internet, but those still require transmitting a negotiable instrument to an untrusted party or over an untrusted channel. Other solutions provide an e-wallet (e.g. Paypal™) but they are usually linked to a real bank account and require the consumer to subscribe to the service (and provide personal information).

In the global economy, there is the need for a payment method that saves the consumer from revealing any financial information to untrusted parties or over an untrusted channel such as the Internet. There is also a need for unbanked or underbanked consumers who do not have bank accounts and credit cards to perform payment without the exchange of negotiable instruments over the untrusted Internet.

### SUMMARY

According to an illustrative embodiment of the present invention, there is provided a reverse payment transaction system and method for allowing a consumer to make an online purchase from a merchant without providing financial details. The method comprises the steps of:
a. providing a payment identifier associated with the purchase to the consumer;
b. receiving at a point-of-sale the payment identifier from the consumer;
c. providing the payment identifier from the point-of-sale to a payment processor;
d. receiving the invoice at the point-of-sale from the payment processor;
e. receiving payment from the consumer at the point-of sale;
f. indicating to the payment processor that payment of the invoice was made;
g. generating on the payment processor a receipt; and
h. providing the receipt to the point-of-sale.

According to another illustrative embodiment of the present invention, the step of providing the unique payment identifier to the consumer further comprises the sub-steps of:
a1. generating an invoice associated with the purchase;
a2. encoding the invoice;
a3. providing the encoded invoice to a payment processor;
a4. decoding on the payment processor the encoded invoice;
a5. generating on the payment processor a payment identifier associated with the invoice;
a6. storing the invoice and associated payment identifier in a payment processor database; and
a7. providing the payment identifier to the consumer.

### BRIEF DESCRIPTION OF THE FIGURES

Embodiments of the invention will be described by way of example only with reference to the accompanying drawings, in which:

FIG. 1 is a schematic view of the reverse payment transaction system according to an illustrative embodiment of the present invention;

FIG. 2 is a flow diagram depicting the reverse payment transaction method according to an illustrative embodiment of the present invention;

FIG. 3 is a flow diagram depicting an illustrative example of the merchant subscription process;

FIG. 4 is a flow diagram depicting an illustrative example of the invoice registration process;

FIG. 5 is a flow diagram depicting an illustrative example of the invoice payment process;

FIGS. 6A and 6B is a flow diagram depicting an illustrative example of the invoice registration process with external offerings;

FIG. 7 is a flow diagram depicting an illustrative example of the optional insurance process; and

FIG. 8 is a flow diagram depicting an illustrative example of the merchant invoice registration process.

### DETAILED DESCRIPTION

Generally stated, the non-limitative illustrative embodiment of the present invention provides a reverse payment transaction system and method in which the consumer, rather than disclosing his financial details, acquires a unique reference code associated with a bill registered by the merchant in a payment processor database. The consumer than acquits the payment through a trusted channel of choice.

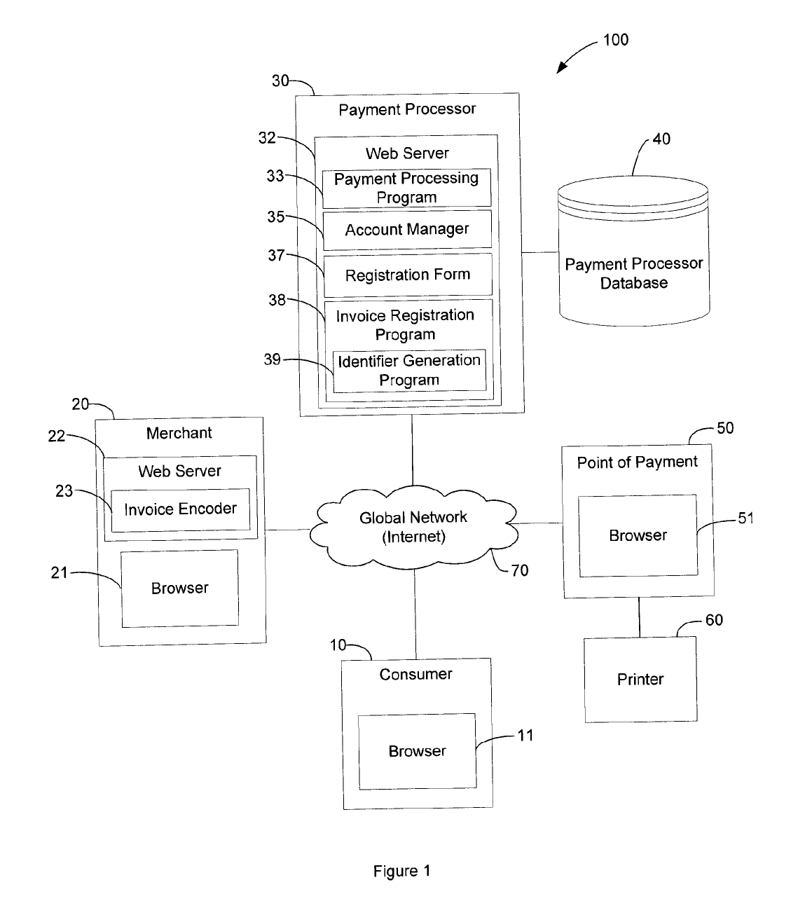

Referring to FIG. 1, there is shown a reverse payment transaction system 100 in which a consumer using a communication device 10 such as a personal computer, a laptop computer, personal assistant device, mobile phone or any other such computing device, on which can run a user interface in the form of a communication software, such as a web browser 11 or other such software, may access a merchant system 20 having a web server 22 providing e-commerce functionalities via an Internet connection 70, for example Ethernet (broadband, high-speed), wireless WiFi, cable Internet, satellite connection, cellular or satellite network, etc.

The merchant system 20 can also be a subsystem of a larger system. Furthermore, the term “merchant” is not meant to be limited to the operators of e-commerce websites, it can also include, for example, product and service providers such as banks.

The merchant web server 22 includes an invoice encoder 23 that can encode invoices in a pre-determined format. Part of the invoice encoder 23 can be provided by a reverse payment processor system 30 and linked to a cryptographic library. The merchant system 20 also includes a user interface in the form of communication software, such as a web browser 21, to access the reverse payment processor system 30 in order to register or manage its account.

The reverse payment processor system 30 includes a web server 32 that hosts an invoice registration program 38 for registering invoices generated by the invoice encoder 23 of the merchant system 20 when a consumer makes a purchase through the merchant web server 22. An identifier generation program 39 generates unique identifiers for invoices registered by the invoice registration program 38 using, for example, a pseudo random number generation algorithm. The reverse payment processor system 30 also includes a payment processing program 33 which allows the retrieval of invoices information and execute payment, a merchant account management program 35 and a registration form 37 to allow merchant systems 20 to create an account with the reverse payment processor system 30 and manage their account. Through the merchant account management program 35, the merchant may change account parameters, list pending and completed payments, cancel pending transactions, etc.

A payment processor database 40, such as a relational database package, stores all of the invoices registered by the invoice registration program 38 along with their unique identifiers generated by the identifier generation program 39.

A point-of-payment device 50 may take the form of, for example, a personal computer, a laptop computer or any other such computing device disposed at a point-of-sale (POS), or a mobile phone, personal assistant device or any other such communication device. The point-of-payment device 50 includes a user interface in the form of communication software, such as a web browser 51, POS software, pluggin or other such software to provide communication with the reverse payment processor system 30 via, for example, the Internet connection 70. In an alternative embodiment, the point-of-payment device 50 may be connected to the reverse payment processor system 30 through a closed proprietary network. The point-of-payment device 50 can also be connected to a printer 60 to be used to print receipts of payment.

### Reverse Payment

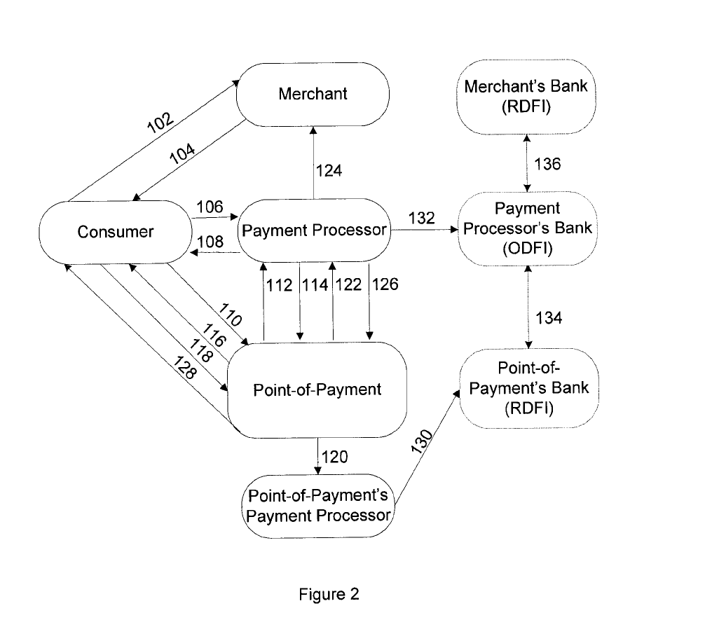

Referring now to FIG. 2, there is shown a diagram of an illustrative embodiment of the reverse payment process 100 describing, with references to FIG. 1, the exchange of information and money between the different parties during a transaction, which are indicated by links 102 to 136.

The process 100 starts at link 102 where a consumer, using a communication device 10, accesses the merchant system 20 web server 22, browses the merchant's list of offered products or services and selects a product or service to purchase.

Then, at link 104, the invoice encoder 23 of the merchant system 20 provides encoded payment information (amount, merchant ID, currency, merchant purchase/transaction identifier, terms and conditions of the sale, etc.) to the consumer communication device 10.

At link 106, the consumer communication device 10 provides the payment information to the invoice registration program 38 of the reverse payment processor system 30, which stores that information in the payment processor database 40, and generates, through the identifier generation program 39, a unique payment identifier (PID) associated with the payment for that transaction. The generated PID is then saved in the payment processor database 40.

Then, at link 108, the reverse payment processor system 30 transmits the PID to the consumer communication device 10. Optionally, the reverse payment processor system 30 may propose POS locations to the consumer based, for example, on his or her billing address/postal code, shipping address/postal code or using an IP geolocation database.

At link 110, the consumer caries the PID to a POS with a point-of-payment device 50 and hands in the PID to the clerk. The clerk enters the PID into the point-of-payment device 50. Alternatively, the point-of-payment device 50 may be a self serve terminal similar to an automated teller machine where the consumer may transfer funds directly from a bank account, use a credit card or through another such means. The point-of-payment device 50 may also be a personal device such as a personal computer or a mobile phone that connects to the web interface of a bank account (i.e., on-line bill payment) or of another payment provider.

At link 112, the point-of-payment device 50 transmits the PID to the payment processing program 33 of the reverse payment processor system 30 and requests the payment details such as the amount and the currency.

At link 114, the reverse payment processor system 30 provides the payment information associated with the PID to the point-of-payment device 50.

Then, at link 116, the clerk charges the consumer for the payment's specified amount. The clerk may also confirm other payment details with the consumer such as the merchant purchase/transaction identifier.

Following which, at link 118, the consumer pays the requested amount by cash or using another payment method accepted by the point-of-payment device 50.

At link 120, the point-of-payment device 50 processes the payment in cash or through a partner payment processor for credit cards, debit cards, or other such payment means. It is to be understood that the partner payment processor may be optional in cases where the point-of-payment device 50 is associated with a bank or other financial services provider that can process credit cards, debit cards and other such payment means.

Then, at link 122, the point-of-payment device 50 notifies the payment processor 30 that the consumer's payment has been processed. It is to be understood that the notification may be performed through a third party system or service such as, for example, an email system integrated with the merchant system 20.

At link 124, the merchant system 20 is notified that the payment has been processed and the amount now appears in the merchant's account. At this time, the merchant may fulfill the consumer's purchase.

At link 126, the reverse payment processor system 30 provides a transaction confirmation identifier (TID) to the point-of-payment device 50. The TID can be used by the consumer has a proof of payment.

Then, at link 128, the point-of-payment device 50 prints for the consumer, using printer 60, a receipt on which appear the TID and the amount paid.

At link 130, either at the end of the day, at predetermined time intervals or at other selected times, the point-of-payment device 50 deposits the consumer payment into the point-of-payment's bank account.

At link 132, once the reverse payment processor system 30 has confirmation that the point-of-payment device 50 has deposited the payment in its bank account (or after a predetermined time period), it debits the point-of-payment's bank account through, for example, an automated clearing house (ACH) network or an e-wallet.

At link 134, either at the end of the month, at predetermined time intervals or at other selected times, if the amount was not already subtracted from the payments collected from the point-of-payment devices 50, the reverse payment processor system 30 pays the commissions due to its point-of-payment partners through, for example an ACH network. This step may vary depending on the business agreement with the point-of-payment partner.

Finally, at link 136, the merchant's money may rest in a “reverse payment” account until he/she requests it to be transferred to its bank account. When the merchant is ready to transfer the money, the reverse payment processor system 30 performs the transfer through, for example, an ACH network.

### Merchant Subscription

The merchant subscription process consists in the merchant enrolling with the reverse payment processor system 30 in order to start accepting payment through the reverse payment transaction system 100 shown in FIG. 1.

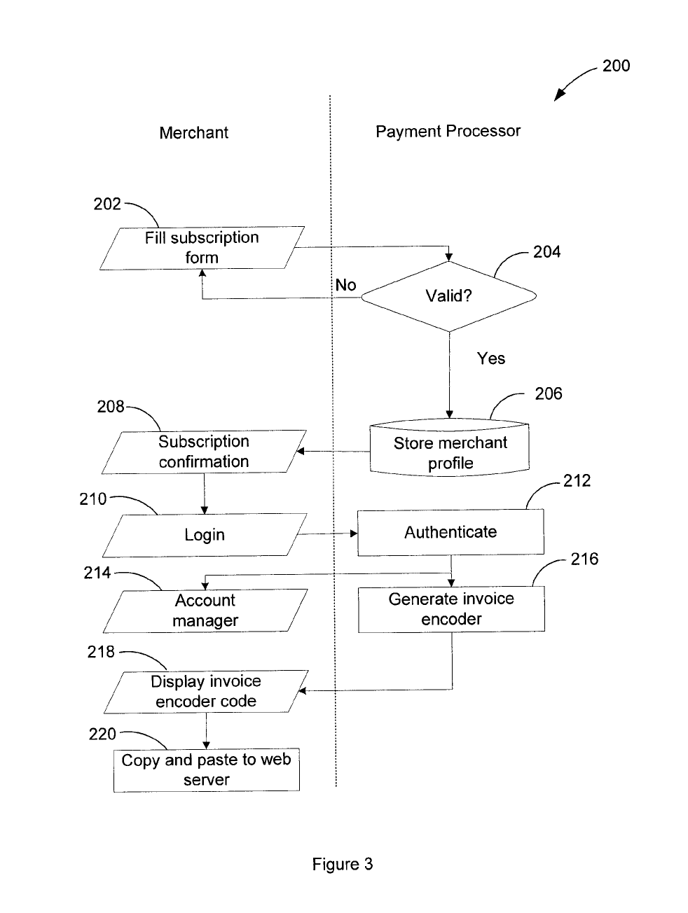

Referring to FIG. 3, there is shown a flow diagram of an illustrative example of the merchant subscription process 200. Steps of the process 200 are indicated by blocks 202 to 220.

The process 200 starts at block 202 where the merchant fills a registration form 37 on the web server 32 of the reverse payment processor system 30 using, for example, the web browser 21 of the merchant system 20.

Then, at block 204, the reverse payment processor system 30 verifies if the form is valid, i.e. that all of the required profile information has been entered (and optionally, performing some validation of the submitted information). If so, the process 200 proceeds to block 206, otherwise it returns to block 202.

At block 206, the reverse payment processor system 30 stores the merchant's profile information in the payment processor database 40. The reverse payment processor system 30 then sends, at block 208, a subscription confirmation to the merchant system 20.

At block 210, the merchant may login into the merchant account manager 35 through the web server 32 of the reverse payment processor system 30 and, at block 212, authenticate his or her account. The merchant may then, at block 214, manage his or her account.

Following a first login into the reverse payment processor system 30, an invoice encoder 23 is generated, at block 216, by the reverse payment processor system 30 and then its code displayed, at block 218, through the web browser 21 of the merchant system 20 so as to allow, at block 220, the merchant to copy and paste the invoice encoder 23 code into the merchant web server 22. The invoice encoder 23 may take the form of a “widget” consisting of HTML and Javascript code, embedded flash, or other component executed directly on the merchant web server 22.

### Invoice Registration

The invoice registration process is performed when a consumer, using the consumer communication device 10, makes a purchase on the merchant system 20 and selects the reverse payment option which is supported by the reverse payment transaction system 100 shown in FIG. 1. This process consists in registering the payment information (e.g. amount, currency, product or service, etc.) in the payment processor database 40 such that it can be paid at a later time.

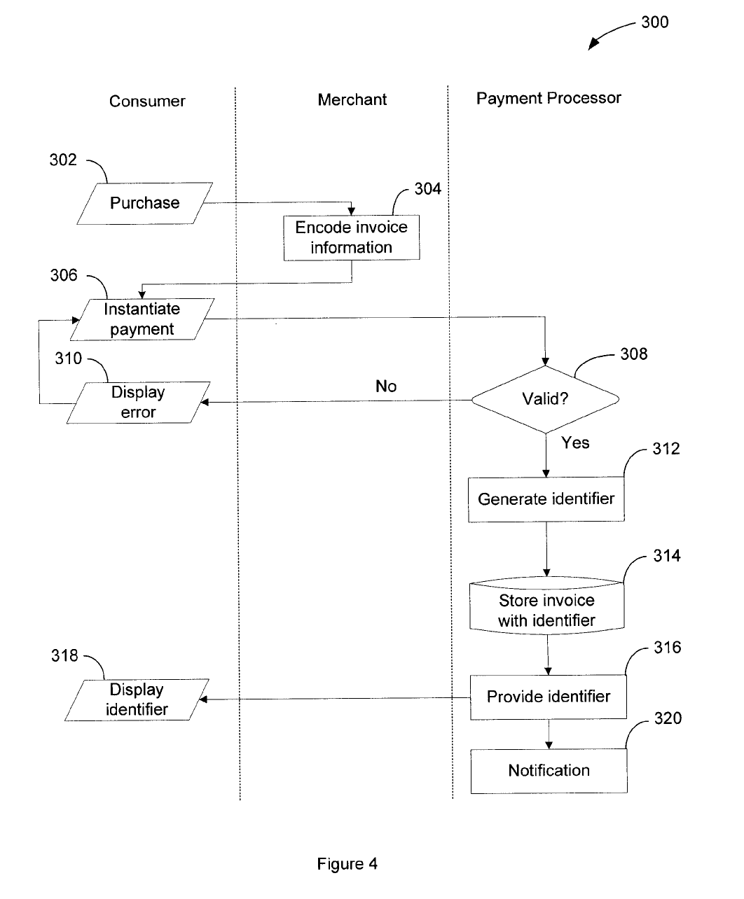

Referring to FIG. 4, there is shown a flow diagram of an illustrative example of the invoice registration process 300. Steps of the process 300 are indicated by blocks 302 to 320.

The process 300 starts at block 302 where a consumer browses web pages on the merchant web server 22 and makes a purchase through the usual website checkout process. This consists in HTTP requests between the consumer's web browser 11 and the merchant's web server 22.

At block 304, when requesting the last page of the checkout process, the payment page, the merchant web server 22 encodes, using the invoice encoder 23, the purchase invoice information (e.g. product or service unique identifier, amount due, currency, etc.) as well as its merchant identifier in a special pre-defined format. This information may be encoded as parameters of a URL to the invoice registration program 38 on the web server 32 of the reverse payment processor system 30. The invoice information may also be encrypted or digitally signed to enhance security. This information is encoded in the payment page in the form of a clickable link, button, image, or widget.

Then, at block 306, the consumer instantiates the registration of the invoice with the invoice registration program 38. In some cases this is done explicitly by the consumer by clicking on the link, button, image, or widget on the payment page on the web server 22 of the merchant system 20. In other cases it may be performed automatically by the web browser 11 of the consumer communication device 10. The web browser 11 then transmits the encoded invoice information to the invoice registration program 38.

At block 308, the invoice registration program 38 decodes the encoded invoice and validates the invoice information (e.g. the amount is positive, the currency is accepted, etc.). In some cases the invoice registration program 38 may also run fraud prevention algorithms to prevent abuses of the reverse payment processor system 30. If the invoice information is not valid, the process 300 displays, at block 310, an error message to the consumer and then returns to block 306. The process 300 may also send a notification of the error to the merchant system 20 through, for example, email, SMS, or other means.

If the invoice information is valid, the process 300 proceeds to block 312 where the PID is generated by the identifier generation program 39 and associated with the invoice. In some embodiment the PID can be unique for the lifetime of the system, in others, for a finite period of time such that the PID may be reused. A pseudo-random algorithm may be used to generate or select the identifier.

Then, at block 314, the invoice information along with the PID are stored in the payment processor database 40. The invoice is then marked as pending (i.e. not paid).

At block 316, the PID is provided to the web browser 11 of the consumer communication device 10 for display following which, at block 318, the PID is displayed to the consumer. The PID can then be copied/pasted, printed, or sent to an email box, a mobile phone, or otherwise recorded.

Finally, at block 320, the invoice registration program 38 may send further notification of the registered pending invoice (e.g. to the merchant system 20).

### Invoice Payment

The invoice payment process is performed when a consumer pays an invoice at a point-of-payment device 50 (e.g. at a brick-and-mortar store) through the reverse payment transaction system 100 shown in FIG. 1. The payment is taken from the consumer at the point-of-payment device 50 on behalf of the reverse payment processor system 30. The point-of-payment device 50 notifies the reverse payment processor system 30 that the payment was made, and in turn the reverse payment processor system 30 can notify the merchant system 20.

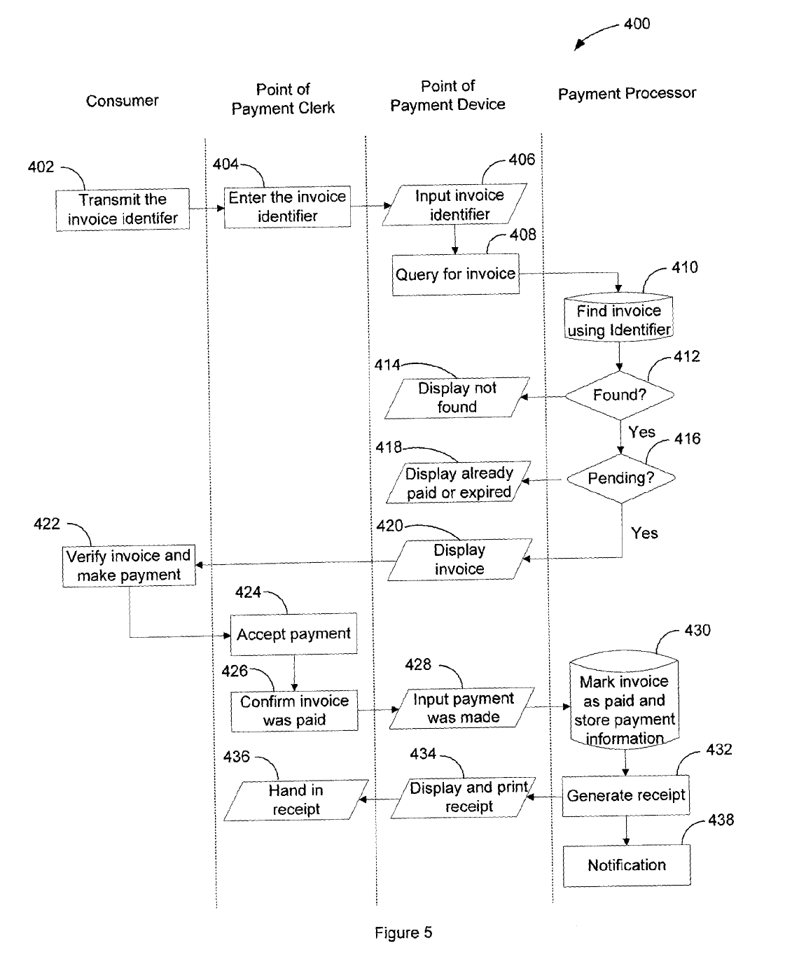

Referring to FIG. 5, there is shown a flow diagram of an illustrative example of the invoice payment process 400. Steps of the process 400 are indicated by blocks 402 to 438.

The process 400 starts at block 402 where the consumer transmits the PID to the clerk (i.e. the person operating the point-of-payment device 50). The transmission can be done orally, with a piece of paper, barcode, or by some electronic transmission mode such as, for example, radio-frequency identification (RFID), Bluetooth or a communication network such as the Internet, supported by both parties.

At block 404, the clerk enters the PID using, for example, a keyboard, a barcode reader, a RFID reader or a Bluetooth interface, which is inputted, at block 406, into the point-of-payment device 50.

At block 408, the point-of-payment device 50 transmits a query with the PID to the payment processing program 33, which, at block 410, retrieves the invoice from the payment processor database 40 using the supplied PID.

Then, at block 412, if the invoice is not found a “not found” message is provided, at block 414, to the point-of-payment device 50 and is displayed to the consumer. If the invoice is found, the payment processing program 33 verifies, at block 416, that the invoice is still pending. In particular, the payment processing program 33 verifies that the invoice has not been paid or has expired. If the invoice has already been paid or has expired, a message is provided, at block 418, to the point-of-payment device 50 and displayed to the consumer.

If the invoice has not been paid, the invoice information (e.g. amount due, currency, purchased product or service identifier, merchant name, etc.) is provided, at block 420, and displayed on the point-of-payment device 50.

At block 422, the consumer confirms the invoice information with the point-of-payment clerk and makes the payment (e.g. in cash, debit card, credit card, or other) to the clerk. The clerk then accepts, at block 424, the payment in cash or by any other suitable payment mean or method.

Following this, at block 426, the clerk inputs in the point-of-payment device 50 that the invoice was paid. It should be noted that at any time the clerk may also cancel the current transaction, for example in cases where the consumer decides not to pay, does not have sufficient funds, or for any other reason. Furthermore, the clerk may also perform verifications about the consumer such as, for example, the consumer's age in cases where the consumer must be at least 18 years old.

At block 428, the point-of-payment device 50 transmits the information to the payment processing program 33 that the payment was received for this invoice and, at block 430, information relative to the payment of the invoice such as the point-of-payment device 50 used for payment and the date and time is stored in the payment processor database 40. The invoice is then marked as paid in the payment processor database 40. At this step other records may also be generated for later audits.

At block 432, a receipt is generated from the payment information by the payment processing program 33 and transmitted to the point-of-payment device 50 as a confirmation of the payment.

The receipt is then displayed, at block 434, on the point-of-payment device 50 and may also be printed on the printer 60.

If the receipt is printed, it is then handed over, at block 436, to the consumer. Alternatively, the receipt may also be transmitted electronically.

Finally, at block 438, notification that the invoice was paid may be sent electronically to the merchant system 20 (e.g. through email or other such communication means).

Invoice Registration Process with External Offerings

The invoice registration process with external offerings is an alternative embodiment of the invoice registration process 300 shown in FIG. 4. In this embodiment, when the consumer makes a purchase on the merchant system 30, additional purchase offerings can be made to the consumer at the time of payment. One such additional purchase offering is insurance on the product or service being bought by the consumer. However, the process equally applies to other offerings and as such will be described in general terms.

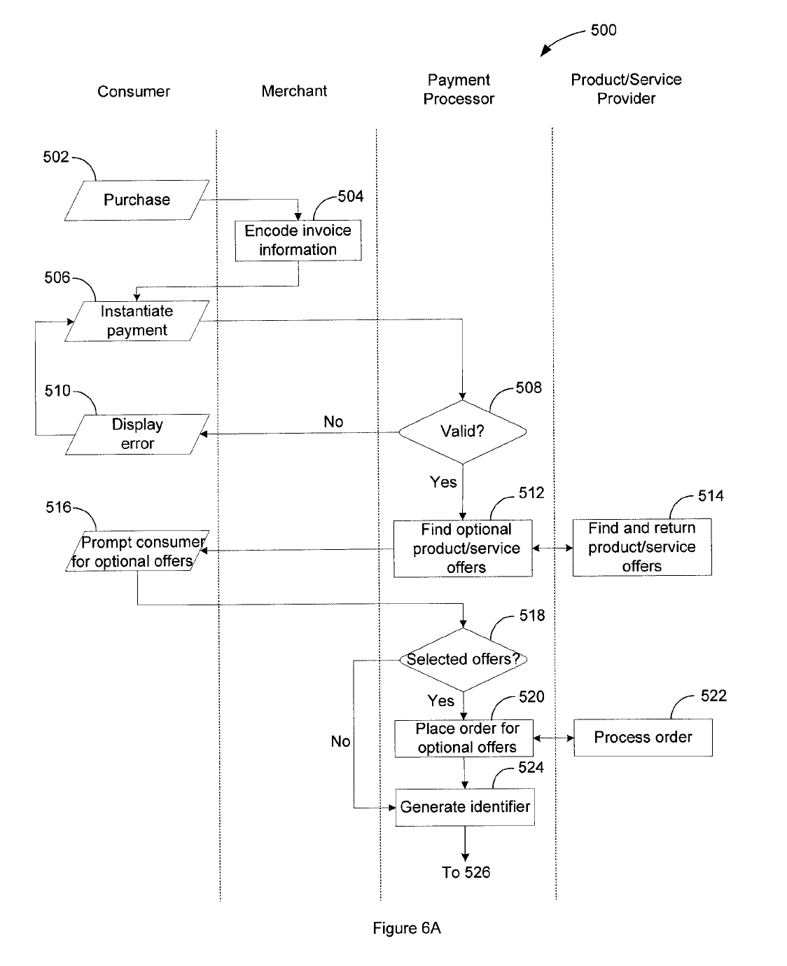

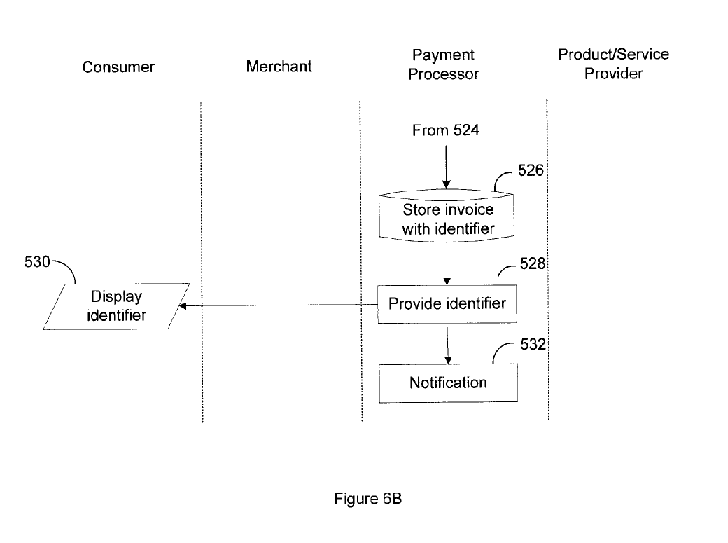

Referring to FIGS. 6A and 6B, there is shown a flow diagram of an illustrative example of the invoice registration with external offerings process 500. Steps of the process 500 are indicated by blocks 502 to 532.

The process 500 starts at block 502 where a consumer browses web pages on the merchant web server 22 and makes a purchase through the usual website checkout process. This consists in HTTP requests between the consumer's web browser 11 and the merchant's web server 22.

At block 504, when requesting the last page of the checkout process, the payment page, the merchant web server 22 encodes, using the invoice encoder 23, the purchase invoice information (e.g. product or service unique identifier, amount due, currency, etc.) as well as its merchant identifier in a special pre-defined format. This information may be encoded as parameters of a URL to the invoice registration program 38 on the web server 32 of the reverse payment processor system 30. The invoice information may also be encrypted or digitally signed to enhance security. This information is encoded in the payment page in the form of a clickable link, button, image, or widget.

Then, at block 506, the consumer instantiates the registration of the invoice with the invoice registration program 38. In some cases this is done explicitly by the consumer by clicking on the link, button, image, or widget on the payment page on the web server 22 of the merchant system 20. In other cases it may be performed automatically by the web browser 11 of the consumer communication device 10. The web browser 11 then transmits the encoded invoice information to the invoice registration program 38.

At block 508, the invoice registration program 38 decodes the encoded invoice and validates the invoice information (e.g. the amount is positive, the currency is accepted, etc.). In some cases the invoice registration program 38 may also run fraud prevention algorithms to prevent abuses of the reverse payment processor system 30. If the invoice information is not valid, the process 500 displays, at block 510, an error message to the consumer and then returns to block 506. The process 500 may also send a notification of the error to the merchant system 20 through, for example, email, SMS, or other means.

If the invoice information is valid, the process 500 proceeds to block 512 where the invoice registration program 38 uses the description of the purchased product or service to find other relevant product or service offerings to be optionally suggested to the consumer. An example of a relevant product may be, for example, optional insurance offered to the consumer to insure its payment and purchase. The external products or services that are offered can be configured in the reverse payment processor system 30 by the merchant using the account manager 35. The optional offerings can also be retrieved, at block 514, from an external provider's system or database (e.g. through a web service).

At block 516, the consumer is prompted with the product or service offers and has the option to add them to the invoice or not and then, at block 518, the invoice registration program 38 determines if optional offerings have been selected for purchase by the consumer.

If the consumer has chosen one of the optional offerings the invoice registration program 38 adds the offering to the invoice and places, at block 520, the order with the external provider. The external provider then processes, at block 522, the order of the consumer. The process 500 then proceeds to block 524.

At block 524, the PID is generated by the identifier generation program 39 and associated with the invoice. In some embodiment the PID can be unique for the lifetime of the system, in others, for a finite period of time such that the PID may be reused. A pseudo-random algorithm may be used to generate or select the identifier.

Then, at block 526, the invoice information along with the PID are stored in the payment processor database 40. The invoice is then marked as pending (i.e. not paid).

At block 528, the PID is provided to the web browser 11 of the consumer communication device 10 for display following which, at block 530, the PID is displayed to the consumer. The PID can then be copied/pasted, printed, or sent to an email box, a mobile phone, or otherwise recorded.

Finally, at block 532, the invoice registration program 38 may send further notification of the registered pending invoice (e.g. to the merchant system 20).

### Optional Insurance

The optional insurance process describes a method through which optional insurance premiums can be offered to consumers having purchased a product or service from a merchant system 20. The method consists of a merchant's requesting a real-time quote from an insurance broker for the purchased product or service. The consumer has the choice to purchase the insurance policy or not. The merchant could also choose to purchase the insurance for the consumer. The insurance policy is purchased from an insurance broker by the merchant on behalf of the consumer. In contrast with the invoice registration with external offerings process 500, the optional insurance process is independent of the payment provider and method used.

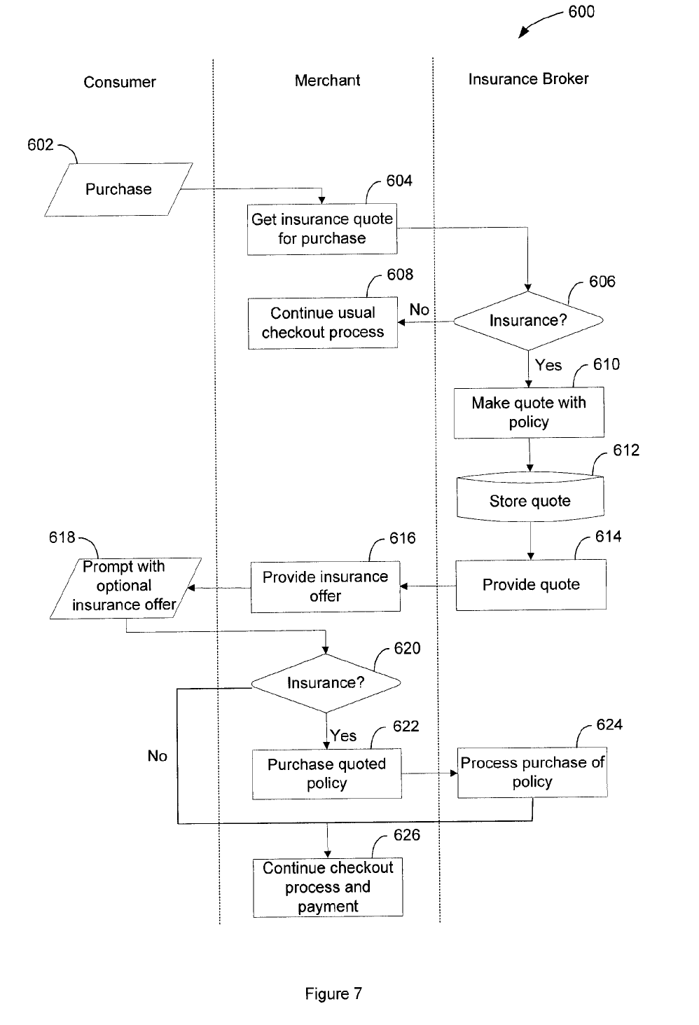

Referring to FIG. 7, there is shown a flow diagram of an illustrative example of the optional insurance process 600. Steps of the process 600 are indicated by blocks 602 to 626.

Process 600 starts block 602 where a consumer, using a communication device 10, accesses the merchant system 20 web server 22, browses the merchant's list of offered products or services and selects a product or service to purchase through the usual checkout process.

During the checkout process, at block 604, while generating one of the check out web pages, the web server 32 of the merchant system 20 requests a policy quote from an insurance broker. The information required by the insurance broker to make a policy quote (e.g. product or service unique identifier, consumer address, currency, etc.) may be encoded by the web server 32 into an HTTP request to a web service. Alternatively, the information may be sent over a secure channel.

Upon receipt of a policy quote request, at block 606, the insurance broker service decides, based on the information provided by the merchant system 20, if the purchased product or service is insurable. Insurance policy for a merchant's product or service would be pre-determined at the time the merchant's registration for the service with the insurance broker.

If the product or service is not insurable, the reason for this is provided, at block 608, to the web server 32 of the merchant system 20, which then continues its usual checkout process.

If the product or service is insurable, the insurance broker dynamically prepares, at block 610, a policy and a premium quote for the product or service to be insured. Both are prepared in real-time based on the pre-entered configuration and on possible variable parameters.

At block 612, the quote is stored in a database of the insurance broker and is assigned a unique identifier.

At block 614, the quote information is provided to the web server 32 of the merchant system 20 including the quote identifier, the premium and links to the details of the policy. The information may be sent, for example, in a XML encoding.

Then, at block 616, the web server 32 of the merchant system 20 extracts the quote information and integrates it into the check out web page of block 604 that is provided to the web browser 11 of the consumer communication device 10. The checkout web page allows the consumer, at block 618, to accept or not refuse the insurance policy offer and provide all the premium information including links to the policy's details.

Following this, at block 618, the web server 32 of the merchant system 20 determines if the consumer decided to accept or refuse the insurance policy offer.

If the consumer decided to accept the insurance policy offer, the web server 32 of the merchant system 20 transmits, at block 622, a purchase request to the insurance broker, which includes the quote identification number and possibly additional information encoded into a HTTP request to the insurance broker web service.

Then, at block 624, the policy purchase request is processed by the insurance broker and, once the purchase of the insurance policy has been completed (or if the consumer decided not to purchase the insurance) the web server 32 of the merchant system 20 continues, at block 626, the usual checkout process.

If insurance has been purchased, the insurance is added to the order and the premium of the policy is added to the total amount of the order. The merchant may also decide to pay for all or part of the premium and adjust the amount of the order accordingly. In an alternative embodiment, the next step of the checkout process may consist in providing information for the consumer to make the appropriate payment.

### Merchant Invoice Registration Process

The merchant invoice registration process is an alternative embodiment of the invoice registration process 300 shown in FIG. 4. In this embodiment, the merchant system 20 registers the invoice with the payment processor 30 on behalf of the consumer. The merchant system 20 transmits the invoice information directly to the payment processor 30 and then displays the PID to the consumer within the web browser 11 of the consumer communication device 10. In this embodiment the consumer communication device 10 does not communicate directly with the payment processor 30.

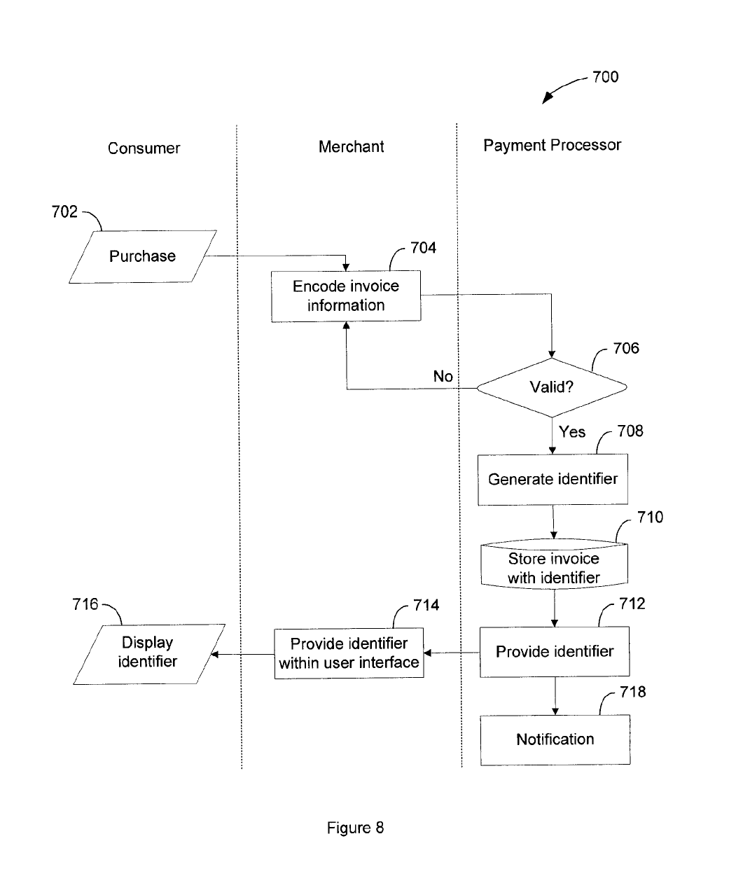

Referring to FIG. 8, there is shown a flow diagram of an illustrative example of the merchant invoice registration process 700. Steps of the process 700 are indicated by blocks 702 to 718.

The process 700 starts at block 702 where the consumer, using a communication device 10, accesses the merchant system 20 web server 22, browses the merchant's list of offered products or services and selects a product or service to purchase.

Then, at block 704, the invoice encoder 23 encodes the payment information (amount, currency, consumer details, etc.) and transmits the encoded information directly to the invoice registration program 38 of the payment processor 30. This may also include a merchant 20 authentication request from the payment processor web server 32.

At block 706, the invoice registration program 38 decodes the encoded invoice and validates the invoice information (e.g. the amount is positive, the currency is accepted, etc.). In some cases the invoice registration program 38 may also run fraud prevention algorithms to prevent abuses of the reverse payment processor system 30. If the invoice information is not valid, the process 700 returns to block 704 where the merchant system 20 is notified that there is a problem with the invoice and may prompt the merchant system 20 to resend the invoice or provide a new one.

If the invoice information is valid, the process 700 proceeds to block 708 where the PID is generated by the identifier generation program 39 and associated with the invoice. In some embodiment the PID can be unique for the lifetime of the system, in others, for a finite period of time such that the PID may be reused. A pseudo-random algorithm may be used to generate or select the identifier.

Then, at block 710, the invoice information along with the PID are stored in the payment processor database 40. The invoice is then marked as pending (i.e. not paid).

At block 712, the PID is provided to the merchant system 20, for example through a web service HTTP request/response, after which, at block 714, the merchant system 20 embeds the PID within its user interface to display, at block 716, the PID through the web browser 11 of the consumer communication device 10. As an example, the PID could by embedded within the HTML of a web page rendered by the web server 22 of the merchant system 20. The PID can then be copied/pasted, printed, or sent to an email box, a mobile phone, or otherwise recorded.

Finally, at block 718, the invoice registration program 38 may send further notification of the registered pending invoice (e.g. to the merchant system 20).

In alternative embodiments of the present invention, the consumer may open an account with the reverse payment processor system 30 and deposit money through point-of-payment devices 50 that can be used to acquit registered bills at a later time.

In another alternative embodiment, the consumer may enter the PID in its mobile phone, and pay with the phone (in regions where mobile phone payment is enabled).

In a further alternative embodiment, billing information may be encoded into code (2D barcode) such that it may be processed offline at the point-of-payment device 50.

Although the present invention has been described by way of particular embodiments and examples thereof, it should be noted that it will be apparent to persons skilled in the art that modifications may be applied to the present particular embodiment without departing from the scope of the present invention.

What is claimed is:

1. A reverse payment transaction method for allowing a consumer to make an online purchase from a merchant without providing financial details, the method comprising the steps of:
a. providing a payment identifier associated with the purchase to the consumer;
b. receiving at a point-of-sale the payment identifier from the consumer;
c. providing the payment identifier from the point-of-sale to a payment processor;
d. receiving the invoice at the point-of-sale from the payment processor;
e. receiving payment from the consumer at the point-of sale;
f. indicating to the payment processor that payment of the invoice was made;
g. generating on the payment processor a receipt; and
h. providing the receipt to the point-of-sale.

2. A reverse payment transaction method in accordance with claim 1, further comprising the step of:
i. sending a notification of the payment of the invoice to the merchant.

3. A reverse payment transaction method in accordance with claim 1, further comprising the step of:
i. providing the receipt to the consumer.

4. A reverse payment transaction method in accordance with claim 1, wherein the step of providing the unique payment identifier to the consumer comprises the sub-steps of:
a1. generating an invoice associated with the purchase;
a2. encoding the invoice;
a3. providing the encoded invoice to a payment processor;
a4. decoding on the payment processor the encoded invoice;
a5. generating on the payment processor a payment identifier associated with the invoice;
a6. storing the invoice and associated payment identifier in a payment processor database; and
a7. providing the payment identifier to the consumer.

5. A reverse payment transaction method in accordance with claim 4, wherein the step of providing the unique payment identifier to the consumer further comprises the sub-step of:
a8. sending a notification of a pending invoice to the merchant.

6. A reverse payment transaction method in accordance with claim 4, wherein the step of providing the invoice to the payment processor is performed by a system of the merchant.

7. A reverse payment transaction method in accordance with claim 4, wherein the step of providing the invoice to the payment processor is performed by a communication device of the consumer.

8. A reverse payment transaction method in accordance with claim 4, wherein the step of encoding the invoice is performed on a system of the merchant.

9. A reverse payment transaction method in accordance with claim 4, wherein the payment identifier is unique for the lifetime of the payment processor.

10. A reverse payment transaction method in accordance with claim 9, wherein the payment identifier is unique for a finite period of time.

11. A reverse payment transaction method in accordance with claim 4, wherein the step of providing the unique payment identifier to the consumer further comprises, after the decoding of the encoded invoice sub-step, the sub-steps of:
a4i. identifying an offering related to the purchase;
a4ii. presenting the related offering to the consumer;
a4iii. prompting the consumer to accept or refuse the related offering; and
a4iv. if the consumer accepts the related offering, placing an order with the related offering provider and adding the related offering to the invoice.

12. A reverse payment transaction method in accordance with claim 4, wherein the step of providing the unique payment identifier to the consumer further comprises, after the decoding of the encoded invoice sub-step, the sub-steps of:
a4v. requesting from an insurance broker an insurance quote for the purchase;
a4vi. generating at the insurance broker the insurance quote;
a4vii. assigning a quote identifier to the insurance quote;
a4viii. storing the insurance quote;
a4ix. presenting the insurance quote to the consumer;
a4x. prompting the consumer to accept or refuse the insurance quote; and
a4xi. if the consumer accepts the insurance quote, placing an order with the insurance broker and adding insurance to the invoice.
